(19) United States
(12) Patent Application Publication
(10) Pub. No.: US 2002/0062566 A1
(43) Pub. Date: May 30, 2002

(54) Cutting device

(76) Inventor: Maximilian Janser, Ehningen (DE)

Correspondence Address: J. Rodman Steele, Jr., Akerman, Senterfitt & Eidson, P.A., Post Office Box 3188, West Palm Beach, FL, 33402-3188, US

(21) Appl. No.: 09/952,996

(22) Filed: Sep. 14, 2001

(30) Foreign Application Priority Data
Sep. 14, 2000 (DE) 10045833.5
Jul. 13, 2001 (DE) 10135269.7

(51) Int. Cl. B26B 29/06

(52) U.S. Cl. 30/290; 30/296.1

(57) ABSTRACT

In a cutting device, which is more particularly used for cutting laid floor coverings, which are preferably fixed flat to the substrate and having a chassis, provided with support means for support on the floor covering, in which the chassis carries at least one cutting tool, which can be transferred into a working position and where the cutting tool is in cutting engagement with the floor covering, the cutting tool is rigidly coupled to the bearing surfaces of the support means in the working position.

As a result, during the cutting process, the inclination or depth of cut of the cutting tool undergoes no modification and an optimum, uniform cutting can be carried out.

### FIELD OF APPLICATION AND PRIOR ART

The invention relates to a cutting device for making cuts in floor coverings according to the preamble of claim 1.

On laying or removing floor coverings, such as carpets, parquet floors, etc., room fitters, floor covering layers, etc. have to perform a number of operating steps. When removing floor coverings, e.g. carpets, which are bonded to the substrate, the covering to be removed is generally cut into webs or lengths and is then removed. The most widely used method is for the fitter or layer to kneel on the floor covering and cut individual webs using a knife. It is necessary to tediously manually draw off the floor covering or to remove it with a winding device, in which a winding mandrel winds up the individual floor covering webs. In order to save the room fitter or floor covering layer the tedious cutting work carried out on the knees and which gives rise to back problems, a number of different tools have been developed. It is e.g. known to fix the knife to a long holding bar, so that the fitter can cut the floor covering from the standing position.

A further development of this holding bar knife is described in DE 299 06 938 U1, where a cutting knife is retained in a knife holder. The knife holder is connected to a handle. Rolls are located on either side of the knife, whose cutting plane is perpendicular to the floor covering, in order to move the entire device over the floor covering. The cutting knife is positioned upstream of the roll in the cutting direction. During the cutting process the floor covering is cut by a type of sliding cut.

U.S. Pat. No. 5,485,676, which provides the basis for the preamble, discloses the clamping retention on a chassis of a cutting tool. The chassis rests on the ground by means of four bearing surfaces (wheels). In order that the cutting tool can be engaged with the substrate to be cut, the chassis must be so deformed by vertical force introduction that the cutting tool blade is brought from the non-engagement position into the working position.

As in the previously described constructions, the disadvantage of this construction is that there is no fixed position between the cutting tool and the material to be cut.

### PROBLEM AND SOLUTION

The problem of the invention is to provide a cutting device which, compared with the prior art, offers improved handling possibilities, together with improved cutting quality and precision.

This problem is solved by a cutting tool according to the invention.

The cutting tool according to the invention is rigidly coupled to bearing surfaces of the support means in the working position.

The term cutting tool in the sense of the present application means knives, e.g. carpet knives or the like. However, it is also possible to use rotating cutting tools, which roll or are separately driven during the cutting process, e.g. cutting disks, etc. The support means can be constituted by wheels, runners or other contact surfaces between the chassis and the floor covering. The cutting tool is in cutting engagement with the floor covering in the working position. If it is moved in its working position it leaves behind a cut in the floor covering. The term floor covering covers all coverings which can be laid flat on a substrate, e.g. carpets, parquet flooring, PVC, roofing felt, insulating mats, etc.

In the case of the holding device described in DE 299 06 93 8 U1, the depth of cut and inclination of the cutting knife with respect to the floor covering can be modified during the cutting process, which leads to irregular cuts. It can even arise that the knife becomes jammed in the floor covering, if the handle is e.g. too strongly adjusted. If it is wished to prevent this, throughout the cutting process the operator would have to keep the handle under a predefined angle relative to the floor covering, which is very difficult to achieve.

This problem does not arise with the cutting device according to the invention. By the bearing surfaces of the support means the cutting tool is fixed in such a way that during the cutting process it is impossible for it to deviate from its preset position relative to the floor covering. The depth of cut and inclination of the cutting tool consequently remain the same throughout the operation, which ensures an optimum, uniform cut.

The cutting tool can have a tool body and a cutting means. In the case of a carpet knife they would be constituted by the shaft or shank and the blade. Preferably the complete cutting tool in the form of tool body and cutting means is removable from the cutting device, i.e. it can be rapidly disengaged and reengaged. This is particularly advantageous if a used or worn blade is to be replaced by a new one. However, it must be borne in mind that as a result of the stable retention of the blade relative to the cutting surface, there can possibly be an abrasion of the blade material on a rough surface located below the material to be cut. This can make necessary a resetting of the sinking in depth of the blade, but as a result of abrasion there is always a sharp cutting edge on the lower extremity of the blade.

In the working position, the cutting means preferably projects through an opening in the chassis in a downwards direction towards the floor covering. The opening can have any conceivable geometry and is preferably a narrow slot, whose width is somewhat greater than that of the cutting means. Thus, the cutting means can at least be laterally guided and is secured against tilting in said direction. The opening is preferably located between two bearing surfaces of the support means.

To keep the free length of the cutting means below the chassis as small as possible, the cutting means preferably projects through the underside of the chassis adjacent to a bearing surface of the support means. The tool body can be placed in fixed manner above the chassis.

Preferably two support means are in each case provided with a bearing surface. The support means can firstly be constituted by a base portion of the chassis and secondly by wheels which are connected to the chassis. The two bearing surfaces of the support means and the cutting tool can form a type of three-point ground contact. Preferably the base portion of the chassis is inclined to the floor covering, e.g. under an angle of 5 to 10 φ. It can support on the floor covering the rear edge of the base portion in the working direction, whereas the remainder of the base portion rests on the wheels connected to the chassis and has no contact with the floor covering. Thus, in the working direction there is a wedge-shaped gap between the base portion and the floor covering. The cutting tool is preferably located between the two bearing surfaces and is in contact with the floor covering in the working position. Thus, during the cutting process, the cutting device is in contact therewith on three axes oriented parallel to the floor covering, namely on the axis through the trailing edge of the base portion, on the axis between the contact point between the cutting tool and the floor covering and on the axis through the bearing point of the wheels. Preferably the cutting tool is placed between the two axes of the support means in such a way that the force introduction point for the operator to introduce force onto the cutting device is also between the two bearing surfaces of the support means.

According to a further development it is possible to adjust the cutting angle which is of an optimum nature relative to the cutting means geometry. This is preferably continuously adjustable in the angular range 30 to 45 φ. The cutting tool is preferably pivotably mounted on the chassis. If e.g. a carpet knife is used as the cutting tool, it can be pivotably mounted on the chassis using a hole or bore formed at the shaft end by means of a stop screw forming a rotation axis.

In particularly preferred manner it is possible to adjust the engagement depth of the cutting means in the floor covering, so that the depth of cut of the cutting tool can be adapted to different floor covering thicknesses. Vertical adjustment could take place by sliding the cutting tool along an axis perpendicular to the floor covering. However, it can also take place jointly with an inclination setting, in that the cutting tool is pivoted-towards the floor covering. The cutting tool can e.g. be guided in a type of guide cage, which is connected to a setscrew. By turning the setscrew it is possible to move the guide cage towards or away from the floor covering.

It is possible to provide on the cutting device a holding bar for operating, particularly sliding said cutting device. Preferably a position of the cutting tool relative to the floor covering is independent of the holding bar position. This ensures that an inclining of the holding bar during the cutting process has no effect on the inclination or depth of cut of the cutting tool. Thus, during the cutting process, the operator could move the holding bar backwards and forwards without this impairing the cut. The holding bar can be articulated to the chassis, e.g. by means of a fork, which is connected to one end of the holding bar and pivotably mounted on the chassis.

According to a further development of the invention the cutting device has a marking device enabling the marking in the floor covering of the cuts made by the cutting tool. This is more particularly helpful if e.g. carpets with a high tuft are being worked, in which it would otherwise be difficult or even impossible to detect the cutting lines. The marking device is preferably a marking pen, e.g. a felt tip pen, which can be inserted in a holder on the chassis. Preferably the marking pen only presses with its force of gravity on the floor covering, so that it is subject to relatively little wear. However, it would also be possible to use other marking means, e.g. chalk, which marks in the manner of a chalking trolley for sports grounds.

The cutting device can have a lever element with which the cutting means can be sunk into the floor covering at the start of the cutting process. Preferably the lever element is part of the chassis constructed as a footboard, so that the cutting means can be pressed into the floor covering by foot pressure.

It is possible for the cutting device to have a spacing or distance indicator, which can have a rod, which is connected in transversely adjustable manner to the chassis. As a result the floor covering can be cut into webs of equal width without the operator having to measure the floor covering beforehand and mark the individual webs.

The chassis support means can be constituted by a bearing bracket. It is preferably the rearmost support means in the working direction. Instead of being supported directly on the base plate of the chassis, the cutting device can be supported on the bearing bracket. The bearing bracket is preferably constructed in such a way that it cooperates with the cutting means, i.e. particularly the cutting knife. Preferably the cutting through of the floor covering takes place in the vicinity of the bearing bracket. The bearing bracket can comprise at least one base plate, as well as a fastening portion and a connecting portion. The fastening portion is e.g. constructed parallel to the chassis. The connecting portion projects perpendicularly downwards and to it is fixed the base plate. It is substantially horizontally oriented. In the base plate can be formed a slot, in which the cutting means can engage and is then in particular laterally supported on the base plate. The cutting means preferably does not project downwards through the slot and instead the lower end of the cutting means is in the vicinity of the slot. This inter alia ensures that on setting up the cutting device there is no damage to the substrate located below the latter. This is particularly critical if the substrate is a foil or sheet material. Separation on the bearing bracket serves to ensure that the substrate of the floor covering to be worked located below the covering material to be cut is not damaged. This is particularly advantageous if there are several superimposed floor coverings and only part of these are to be separated. Such applications e.g. arise at landfills or ponds with several superimposed sheets, where in the case of a water barrier consisting of several sheet layers only the uppermost sheet is to be cut through, whereas the sheets below it are to remain undamaged. The bearing bracket preferably has a base plate with a bevel. The bearing bracket rests on the substrate to be worked and slides on it, whilst the floor covering to be worked is conveyed over the bevel to the cutting point on the bearing bracket and is there cut through using the cutting means. The bearing bracket protects the cutting means from damage when not in use. The bearing bracket also provides protection against injury by the cutting means, because direct access to the blade is impossible. It is also possible to set down the cutting device anywhere without having to fear damage occurring to the substrate through the cutting means.

These and further features can be gathered from the claims, description and drawings and the individual features, both singly and in the form of subcombinations, can be implemented in an embodiment of the invention and in other fields and can represent protectable constructions for which protection is hereby claimed. The subdivision of the application into individual sections and the subheadings in no way limit the general validity of the statements made thereunder.

### BRIEF DESCRIPTION OF THE DRAWINGS

Embodiments are described in greater detail hereinafter relative to the attached drawings, wherein show:

FIG. 1 A three-dimensional view of a first embodiment of the cutting device.

FIG. 2 A diagrammatic side view of the first embodiment of the cutting device.

FIG. 3 A larger scale side view of a detail of a second embodiment of the cutting device.

### DETAILED DESCRIPTION OF EMBODIMENTS

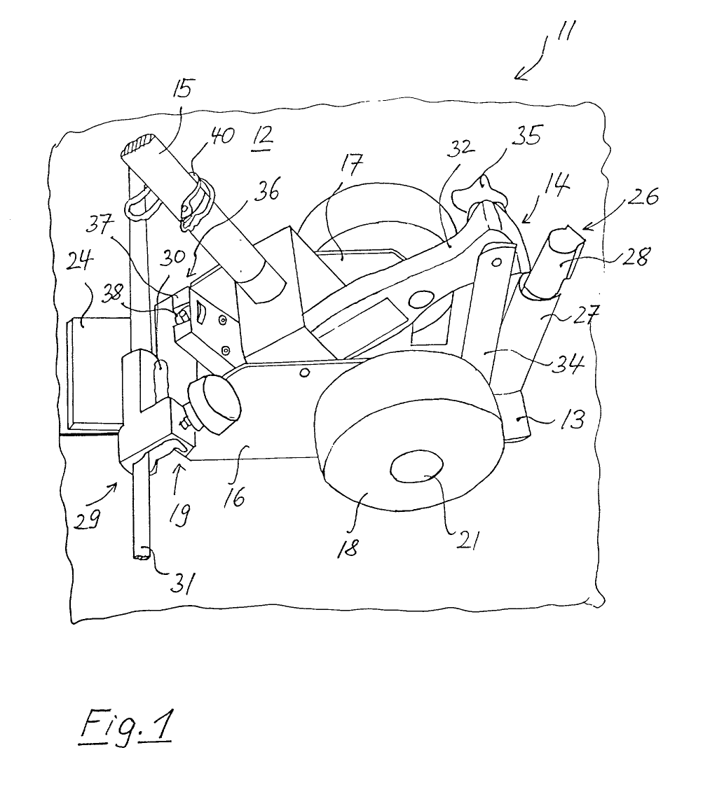

FIG. 1 shows a first embodiment of the cutting device 11 for cutting floor coverings 12 laid out preferably flat on the substrate. The cutting device 11 essentially comprises a chassis 13, a cutting tool 14 fitted to the chassis and a holding bar 15 connected to the chassis 13. One particular application is the cutting of laid, bonded fitted carpets.

The chassis 13 has a U-shaped cross-section with two side portions 16, which are parallel to one another and perpendicular to the floor covering, as well as a base portion 17 connected to the side portion 16. The chassis 13 has support means 18, 19 supported on the floor covering 12. In the described embodiment there are two support means 18, 19, namely wheels, which are connected to the chassis 13 and the trailing edge of the chassis in the working direction 20 of the cutting device 11. Thus, the base portion 17 is inclined to the floor covering 12 and is supported on its trailing edge in the working direction 20, whereas the front part of the base portion 17 rests on the wheel axle 21. Thus, in the movement direction 20 a wedge-shaped gap is formed between the base portion 17 and the floor covering 12. The wedge angle is e.g. approximately 3 to 10 φ. However, it is also conceivable to have a steeper setting of the base portion 17. The support means 18, 19, i.e. the rear or trailing edge of the chassis 13 and the wheels, are in contact with the floor covering 12 at their bearing surfaces 22, 23. In the case of the wheels the bearing surface 22 is limited to a narrow, approximately linear area. The bearing surface 23 of the trailing edge is also approximately linear. The size of the bearing surfaces 22, 23 is mainly linked with the characteristics of the floor covering 12. In the case of working a soft floor covering, e.g. a carpet with a high tuft or a soft PVC covering, the wheels or the trailing edge can sink into the floor covering and are supported on one surface. Through the two wheels of the chassis 13 and its trailing edge a type of three-point ground contact on the floor covering 12 is created. As an extension to the trailing edge of the chassis 13 is provided an upwardly offset lever element 24 in the manner of a footboard. By pressure on the lever element 24 the cutting tool 14 can be sunk into the floor covering 12. A marking device 26 is provided at the front end of the chassis 13 in the working direction 20. The marking device 26 comprises a holder 27 and a marking means 28, such as e.g. a felt tip pen, which can be inserted in the holder 27. The marking means 28 rests under its own force of gravity on the floor covering 12. A distance or spacing indicator 29 is fixed by a weld 30 to the rear end of the chassis 13 in the working direction 20. The spacing indicator 29 comprises a type of chassis-side screw clip in which is held in positionally variable manner a rod 31.

In the embodiment described the cutting tool 14 is a carpet knife. It comprises a shaft or shank constructed as a tool body 32 and a blade constructed as the cutting means 33. The shaft is pivotably mounted above the chassis 13. For mounting purposes is provided a retaining clamp 34, which bilaterally flanks the shaft end. A stop screw 35 traverses corresponding tapholes of the retaining clamp and a through-bore at the blade-remote end of the shaft. The stop screw 35 forms a rotation axis for the cutting tool 14 and otherwise holds it in positionally defined manner. By firmly rotating the stop screw 35 it is possible to secure the shaft against lateral tilting. In the vicinity of the transition from shaft to blade, the latter is held in a guide cage constructed as a guide device 36. The guide device 36 is connected by two screws to the shaft 13. The guide device 36 essentially comprises three parts, namely a base part 37, a knurled-head screw 38 and a not shown guide cage. The knurled-head screw 38 is mounted in the base part 37 and connected to the guide cage. By turning the knurled-head screw 38 the guide cage can be moved towards or away from the floor covering 12, which brings about the vertical adjustability of the cutting tool 14.

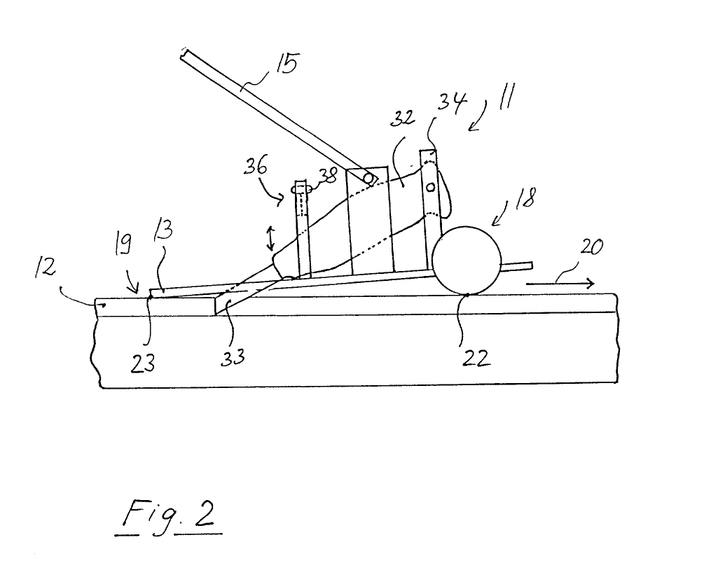

As can be seen in FIG. 2, the cutting means 33 constructed as a blade projects through an opening on the base portion 17 of the chassis 13 into the floor covering 12. The angle between the cutting means 33 and the floor covering 12 is always the same during the operation and is in the range between 30 and 45 φ and is preferably approximately 35 φ and consequently corresponds to the optimum angle of cut of the blade.

A holding bar 15 is provided for operating the cutting device 11. The holding bar 15 is connected by a clip device 40 to a holding fork 41, which is articulated to both side portions 16 and 17 of the chassis.

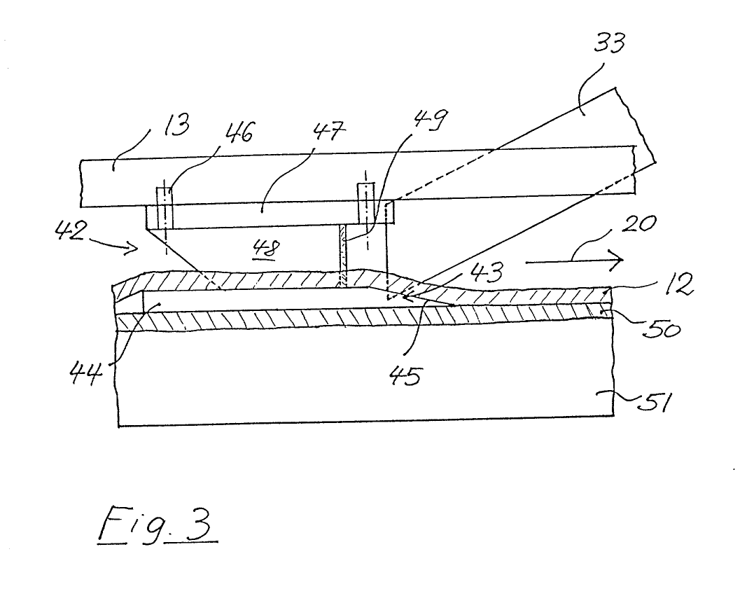

FIG. 3 shows a second embodiment of the cutting device 11. It differs from the first embodiment in that as the support means 19 is provided a bearing bracket 42 in place of the trailing edge 13 of the chassis. The bearing bracket 42 is detachably fixed by fixing means 46 to the underside of the chassis 13. The fixing means can be screws, clamp or clip devices, etc.

The bearing bracket essentially comprises three parts, namely a fixing portion 47, a connecting portion 48 and a base plate 44. By means of the fixing portion 47, which is constructed as a flat plate parallel to the chassis 13, using the fixing means 46 of the bearing bracket 42 detachable fixing can take place to the underside of the chassis 13. The connecting portion 48 projects vertically downwards from the fixing portion 47. The connecting portion 48 has on its front side located in the working direction a type of blade 49, which during the further conveying of the floor covering strips assists in that it serves as a cutting member for the cut floor covering. Below the connecting portion 48 is located the base plate 44. At the top the connecting portion 48 is connected to the base plate 44 and at the bottom to the fixing portion, e.g. by means of a welded joint. Additionally or alternatively a press fit of the connecting portion 48 in slots on the fixing portion 47 or base plate 44 is possible. The base plate 44 slides over the substrate of the floor covering to be worked, e.g. a further floor covering 50 or a substrate 51. On its front side in the working direction 20, the base plate 44 has a bevel 45. In the vicinity of this bevel 45 or, considered in the working direction, shortly behind it, is located the cutting point 43 for the floor covering, i.e. the point at which the cutting means 33 cuts through the floor covering. The cutting means 33 is guided in a slot and in the vicinity of the latter can project into the bevel 45 of the base plate 44. However, between the substrate, e.g. the further floor covering 50, and the lower edge of the cutting means 33, there is always a spacing X in order not to cause damage to the same.

### OPERATION

Firstly, by means of the spacing indicator 29, the web width, i.e. the spacing to be maintained between two cuts is set. The screw of the screw clamp is loosened and the rod 31 is engaged with a reference point, e.g. the wall. Then the screw on the screw clamp is tightened and the spacing is preset, so that the floor covering 12 can be cut into webs of equal width. The knife is then introduced into the cutting device 11. For this purpose the stop screw 35 on the holding clamp 34 is loosened, so that the cutting tool 4, e.g. a carpet knife, can be slid into the cutting device 11. The shaft of the cutting means 33 constructed as a tool body 32 is guided by the guide cage of the guide device 36. Following the introduction of the cutting tool 14, the stop screw 35 is tightened, so that the holding clamps 34 are drawn together and the shaft of the cutting means 33 is secured against lateral tilting. Then adjustment takes place on the cutting tool 14 to ensure the desired depth of cut. The necessary depth of cut is dependent on the thickness of the floor covering 12 to be worked. Preferably the depth of cut is set in such a way that the floor covering 12 is completely cut through. If several coverings are superimposed, the depth of cut can also be chosen in such a way that only part of the coverings is cut through, whereas coverings below the same remain undamaged. The setting of the depth of cut takes place with the guide device 36 and the guide cage. The cutting tool blade can e.g. be a trapezoidal knife or a hook blade of a carpet knife. By turning the knurled-head screw 38 the tool body 32 and consequently the blade-type cutting means 33 is guided in the direction of the floor covering 12. When the desired depth of cut has been set, the cutting device 11 is brought into the starting position. By foot pressure on the lever element 24 the blade can be pressed into the floor covering 12. As shown in FIG. 3, in the second embodiment of the cutting device 11 the bearing bracket 42 is brought into the starting position. Then the floor covering 12 to be worked is raised and placed on the bevel 45 of the base plate. During the cutting process the cutting device 11 is moved forwards by means of the holding bar 15. In the working direction 30 the holding bar 15 is substantially perpendicular relative to the cutting tool 14. Thus, in the described embodiment, the cutting tool 14 performs a dragging cut in the manner of a plough. In the working direction 20, the cutting area of the cutting tool 14 is behind the bearing surface 22 of the wheels. Throughout the cutting process the cutting tool 14 is rigidly coupled with the beating surfaces 22, 23 of the support means. The inclination and depth of cut of the cutting tool 14 can not diverge from the preset position during the cutting process. A position change of the holding bar 15 also does not alter this position. This ensures a uniform cutting through of the floor covering 12. For marking the cut performed by the cutting tool 14 a marking device 26 is provided. This enables the operator to detect the position of the already made cuts and perform the next cut with the spacing set on the spacing indicator.

In the second embodiment, if the cutting device 11 is moved in the working direction 20, the floor covering 11 to be worked is raised by the wedge-shaped bevel 49 from the substrate, e.g. a further floor covering 50 and conveyed to the cutting point 43 on the bevel 45. At the cutting point 43 is located the cutting means 33 which cuts the floor covering 12 into strips. The cut through floor covering strips are conveyed on to the right and left of the connecting portion 47 on the base plate 44 until at the end of the latter they again drop onto the substrate. The blade 49 ensures that separation takes place of any not completely cut through floor covering material.

Following the cutting process the cutting tool can be set back or reset, so that e.g. the blade is located in or above the opening on the base portion 17. This ensures a secured non-use position in which the cutting device can be safely transported.

1. Cutting device, particularly for cutting laid floor coverings, having a chassis, which is provided with support means for support on the floor covering, the chassis carrying at least one cutting tool, which can be brought into a working position where the cutting tool is in cutting engagement with the floor covering, wherein the cutting tool (14) is rigidly coupled to the bearing surfaces (22, 23) of the support means (18, 19) in the working position.

2. Cutting device according to claim 1, wherein the cutting tool (14) has a tool body (32) and a cutting means (33).

3. Cutting device according to claim 2, wherein, in the working position, the cutting means (33) projects downwards onto the floor covering (12) through an opening in the chassis (33).

4. Cutting device according to claim 3, wherein, the cutting means (33) were located between two bearing surfaces (22, 23) of the support means (18, 19).

5. Cutting device according to claim 2, wherein the cutting means (33) projects through the underside of the chassis (13) adjacent to a bearing surface (22, 23).

6. Cutting device according to claim 2, wherein the tool body (32) is fixed above the chassis (13).

7. Cutting device according to claim 1, wherein the support means (18, 19) are constructed in such a way that they form a three-point ground contact.

8. Cutting device according to claim 1, wherein it is possible to set the optimum cutting angle for the cutting means geometry.

9. Cutting device according to claim 7, wherein the cutting angle is in the range 30° to 45°.

10. Cutting device according to one of the preceding claims, wherein the cutting tool (14), particularly its tool body (32), is pivotably mounted on the chassis (13).

11. Cutting device according to one claim 1, wherein it is possible to adjust the engagement depth of the cutting means (33) in the floor covering.

12. Cutting device according to claim 11, wherein the engagement depth is adjusted by turning a setscrew, which is coupled to a guide device for guiding the cutting tool (140.

13. Cutting device according to one claim 1, wherein a holding bar (15) is provided for sliding the cutting device, the position of the cutting tool relative to the floor covering being independent of the holding bar position.

14. Cutting device according to claim 13, wherein the holding bar is articulated to the chassis.

15. Cutting device according to claim 1, wherein it has a marking device (26) for marking the cut performed by the cutting tool (14).

16. Cutting device according to claims 1, wherein it has a lever element (24) acting on the chassis for sinking the cutting means into the floor covering.

17. Cutting device according to claim 1, wherein a support means constructed as a bearing block (42) is provided, said bearing block (42) having a base plate, which raises from the substrate the covering material to be cut through.

18. Cutting device according to claim 17, wherein a cutting point (43) for cutting through the floor covering is directly provided at the bearing block (42), said cutting point (43) being located above the base plate (44) of the bearing block (42).

19. Cutting device according to claim 18, wherein the base plate (44) has a bevel (45), through which it is possible to raise the floor covering to be worked from the underlying substrate and guide it to the cutting point.
